(19) United States
(12) Patent Application Publication
(10) Pub. No.: US 2009/0022406 A1
(43) Pub. Date: Jan. 22, 2009

(54) Method for finding specific pattern and method for compensating image offset

(75) Inventors: Chung-Hwa Chang, Taipei (TW); Hsin-Ching Su, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC., Taipei (TW)

(21) Appl. No.: 12/219,282

(22) Filed: Jul. 18, 2008

(30) Foreign Application Priority Data
Jul. 20, 2007 (TW) 096126696

(51) Int. Cl. G06K 9/68

(52) U.S. Cl. 382/218

(57) ABSTRACT

A method for finding a specific pattern is used to find a specific pattern in an image to be tested. The method comprises the following steps of: acquiring an image to be tested; performing a binary thresholding process on the image to be tested, thereby transforming the image to be tested into a binary image; performing a mosaic process on the binary image, thereby transforming the binary image into a mosaic image; utilizing a correlation coefficient method to find the specific pattern most similar to an image template from the mosaic image, wherein the image template is a desired mosaic pattern of the specific pattern; and transforming the mosaic image back into the binary image so as to find the coordinate of the specific pattern accurately.

### FIELD OF THE INVENTION

The invention relates to a method for finding a specific pattern, and more particularly to a method for compensating an image offset by implementing the above-mentioned finding method.

### BACKGROUND OF THE INVENTION

As the technology advances and reaches the era, where every electronic element tends toward slim, thin and compact for portability and economize the storage space. For instance, several electronic elements are mounted in a single printed circuit board, which has a layout of relatively dense circuit paths. Therefore, assembling of the electronic elements and inspecting thereof are gradually replaced by automatic machinery so as to increase production, operation speed, precision and yield of electronic products.

Machine vision system is mainly applied in the automatic production and optical inspection line. The application of the machine vision is generally divided into four functions including location, meaurement, decode, and defect inspection. Moreover, some machine vision system contains several above-mentioned functions simultaneously. For instance, the vision system may be utilized to capture an image of the printed circuit board and to decode the image so as to inspect whether the electronic elements on the printed circuit board are missing or mislocated, or to measure the position accurancy of the electronic element on the motherboard.

During the optical inspection and automatic production process carried out by the machine vision system, the most important thing is to find the correct position, only then the succeding action is provided with accurancy. The machine vision system generally offers offset-compensating ability to compensate position offset of the project or product to be tested. According to the conventional technology, the printed circuit board has a reference circle pattern, that is utilized for performing the step of automatic offset compensation.

First of all, the machine vision system applies CCD (charge couple device) camera to capture an image on the printed circuit board. The portion of the printed circuit board that contains the above-mentioned reference circle pattern of the image to be tested is designated. Next, a binary thresholding process is performed on the image to be tested. By utilizing the boundary finding method, the boundary coordinate of the circle is achieved. A circle can be determined by three points, therefore the reference center coordinate can be obtained according to the coordinate data of three boundary points by using circumscribed circle method or according to coordinate data of several boundary points by using least square estimation. Finally, the machine vision system compensates the image offset amount based on the reference center coordinate.

Note that it takes relatively long operation time for finding the reference circle and the reference center coordinate thereof, thus the automatic production or inspection process of the electronic element requires a relatively long time for compensating the image offset. It is urgently needed for the manufacturers how to increase the inspection speed of the machine vision and shorten the required time of the machine vision system for automatic offset compensation.

### SUMMARY OF THE INVENTION

The object of the present invention is to utilize a rough image adjustment process (mosaic process) to increase the speed in finding a specific pattern within an image. Afterwards, a fine image adjustment process is conducted to find accurately the center coordinate of a circle pattern.

The other object of the present invention is to provide a method for finding the center coordinate of a circle pattern accurately and rapidly during image offset compensating operation. The method selects two secants randomly along the X-axis and the Y-axis of the circle pattern, and then acquires the coordinate of the center points of the secants along the X-axis and the Y-axis, wherein the coordinate of the center points is the center coordinate of the circle pattern.

In one aspect of the present invention, a method for finding a specific pattern is provided. The method is utilized for finding a center coordinate of a circle pattern within an image to be tested. The method includes the steps of: capturing the image to be tested; performing a binary thresholding process on the image to be tested, thereby transforming the image to be tested into a binary image; performing a mosaic process on the binary image, thereby transforming the binary image into a mosaic image; utilizing a correlation coefficient method to find the circle pattern most similar to an image template from the mosaic image, wherein the image template is a desired mosaic pattern of the circle pattern; acquiring an approximate coordinate of the circle pattern; transforming the mosaic image back into the binary image; acquiring boundary coordinates x₁, x₂, y₁ and y₂ of the circle pattern respectively by using the approximate coordinate of the circle pattern as an initial point of a X-Y coordinate system to extend along a X-axis and a Y-axis; and setting the center coordinate of the circle pattern as

$$( \frac{{x}_{1} + {x}_{2}}{2} , \frac{{y}_{1} + {y}_{2}}{2} ) .$$

In a second aspect of the present invention, a method for finding a specific pattern is provided. The method is utilized for finding the specific pattern in an image to be tested. The method includes the steps of: capturing the image to be tested; performing a binary thresholding process on the image to be tested, thereby transforming the image to be tested into a binary image; performing a mosaic process on the binary image, thereby transforming the binary image into a mosaic image; and utilizing a correlation coefficient method to find the specific pattern most similar to an image template from the mosaic image, wherein the image template is a desired mosaic pattern of the specific pattern.

In a third aspect of the present invention, a method for compensating an image offset is provided. The method is utilized for compensating offset of an image to be tested that includes a circle pattern implemented to assist positioning. The method includes the steps of: setting a standard center coordinate of the circle pattern; capturing the image to be tested; performing a binary thresholding process on the image to be tested, thereby transforming the image to be tested into a binary image; performing a mosaic process on the binary image, thereby transforming the binary image into a mosaic image;

utilizing a correlation coefficient method to find the circle pattern most similar to an image template from the mosaic image, wherein the image template is a desired mosaic pattern of the circle pattern; acquiring an approximate coordinate of the circle pattern; transforming the mosaic image back into the binary image; acquiring boundary coordinates x₁, x₂, y₁ and y₂ of the circle pattern respectively by using the approximate coordinate of the circle pattern as an initial point of a X-Y coordinate system to extend along a X-axis and a Y-axis; setting a center coordinate of the circle pattern as

$$( \frac{{x}_{1} + {x}_{2}}{2} , \frac{{y}_{1} + {y}_{2}}{2} ) ;$$

acquiring an offset amount between the standard center coordinate and the center coordinate of the circle pattern; and re-positioning the image to be tested by using the offset amount as a position compensation value.

### BRIEF DESCRIPTION OF THE DRAWING

Other features and advantages of this invention will become more apparent in the following detailed description of the preferred embodiment of this invention, with reference to the accompanying drawings, in which:

FIG. 1 illustrates a printed circuit board having an imaged to be tested;

FIG. 2 illustrates a binary image of the image to be tested shown in FIG. 1;

FIG. 3 illustrates a mosaic image and an image template of the binary image shown in FIG. 2;

FIG. 4 is a schematic view showing how the center coordinate of a circle pattern is acquired; and

FIG. 5 is a process diagram showing the method of finding a specific pattern according to the present invention.

### DETAILED DESCRIPTION OF THE PREFERRED EMBODIMENT

The method for finding a specific pattern of the present invention is implemented in the processes of optical inspection and automatic production so as to significantly improve the required operation time of the machine vision system for the automatic offset compensation. In order to clearly describe the finding method of the present invention, an image to be tested of a printed circuit board is illustrated for exemplification.

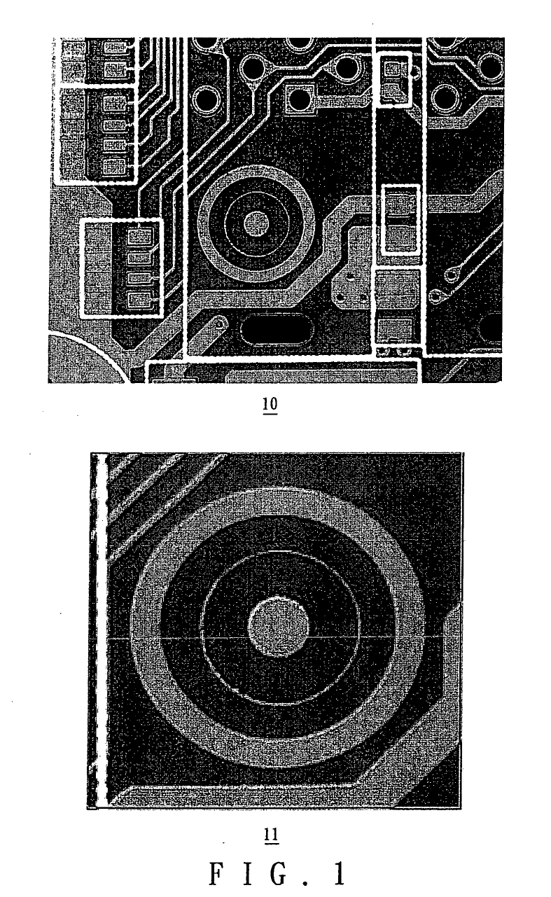

The method for finding a specific pattern of the present invention is utilized for finding a center coordinate of a circle pattern within an image to be tested. Firstly, the image to be tested is captured with the assistance of a CCD (charge couple device) camera. FIG. 1 is a diagram showing a printed circuit board having the image to be tested. The image 10 to be tested includes a circle pattern serving as an optical positioning point that is used for position correction. In one preferred embodiment, an image range of an image 11 to be tested that has a circle pattern is designated optionally in advance from the image 10 to be tested, thereby minimizing the entire range and thus quicken the operation time for finding the circle pattern.

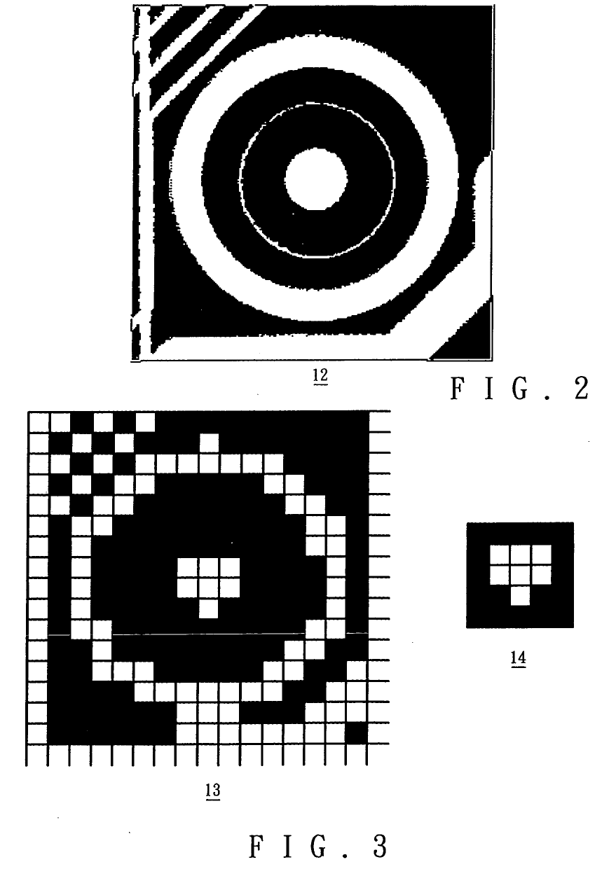

A binary thresholding process is performed on the image 11 to be tested, thereby transforming the image 11 to be tested into a binary image 12. Referring to FIG. 2, FIG. 2 shows a binary image of the image 11 to be tested. A threshold value is defined according to a color tone and a brightness of the image 11 to be tested, wherein in the image to be tested, the image that has a brightness value larger than the threshold value is transformed into black color, and the image that has a brightness value smaller than the threshold value is transformed into white color. In other words, the image 11 to be tested is transformed into a binary image 12, which is composed of black color and white color only.

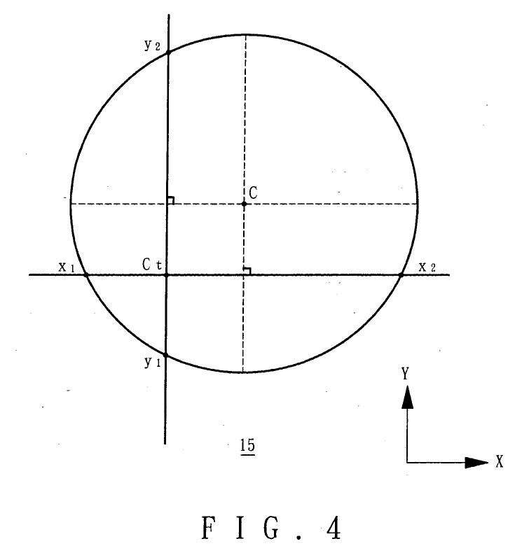

A mosaic process is performed on the binary image 12, thereby transforming the binary image 12 into a mosaic image. Referring to FIG. 3, FIG. 3 shows a mosaic image 13, which is a mosaic image of the binary image 12. During the mosaic process, the binary image 12 is reduced into the mosaic image 13 having N×N pixels according to weight of white spot. Note that the image pixels (number of spots) are significantly reduced during the mosaic process. In addition, ineffective boundaries and noise signals can be also filtered out by this mosaic process, which is the rough image adjustment process of the present invention, to improve the speed and accuracy in the subsequent operation.

The method of the present invention is utilized to find a center coordinate of a specific circle pattern. Therefore, prior to the above-mentioned step, a desired image template of a circle pattern must be established in advance in the machine vision system, wherein this image template is a mosaic pattern. As shown in FIG. 3, an image template 14 is a mosaic pattern having 5×5 pixels.

After transforming the binary image 12 into the mosaic image 13, a correlation coefficient method is utilized to find a circle pattern most similar to the image template 14 from the mosaic image 13. As described above, the image template 14 is the desired mosaic pattern of the circle pattern.

Since the image 11 to be tested is transformed into the mosaic image 13 and the image template 14 required for the correlation coefficient method is also the mosaic pattern, the required calculation amount for finding can be largely decreased, thus increasing the speed of finding and comparison.

After finding the desired circle pattern, an approximate center coordinate of the circle pattern is acquired subsequently. The approximate center coordinate is the rough coordinate of the circle center of the circle pattern within the mosaic image 13. Therefore, the rough coordinate of the circle center of the circle pattern of the mosaic image 13 must be converted into the coordinate of the binary image 12 so as to acquire the center coordinate more accurately. By means of this fine image adjustment process of the present invention, the circle center can be positioned more accurately.

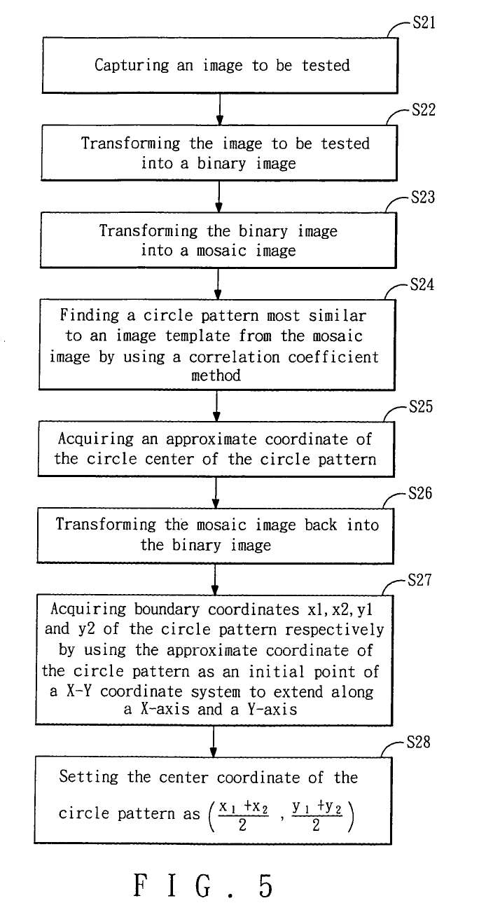

Referring to FIG. 4, which is a schematic view showing how the desired center coordinate of a circle pattern is obtained. The present invention acquires the center coordinate by using the perpendicular bisector of the circle. More specifically speaking, a perpendicular bisector of a random secant on a circle certainly passes through the center of the circle. Therefore, the circle center is located on an intersection point between two perpendicular bisectors of any two secants.

Accordingly, after the image to be tested is transformed back into the binary image 12, the boundary coordinates x₁, x₂, y₁ and y₂ of the circle pattern can be acquired respectively by using the approximate coordinate Ct of the circle pattern as an initial point of a X-Y coordinate system to extend along a X-axis and a Y-axis. Next, a center coordinate of the circle pattern can be set as C

$$( \frac{{x}_{1} + {x}_{2}}{2} , \frac{{y}_{1} + {y}_{2}}{2} ) .$$

This step is performed by using the approximate coordinate Ct of the circle center as the initial point for finding the boundary coordinates from an interior of the circle pattern to an exterior of the circle pattern. However, in accordance with another preferred embodiment, the boundary coordinates can be found from an exterior of the circle pattern to an interior of the circle pattern. However, the interference from noise signal may cause the occurrence of error.

According to forgoing description, the method of finding the specific pattern of the present invention can be simply illustrated with the process diagram shown in FIG. 5. As shown in FIG. 5, an image to be tested (S21) is captured, firstly. The image to be tested is transformed into a binary image (S22). A rough image adjustment is performed for transforming the binary image into a mosaic image (S23). A correlation coefficient method is utilized to find the circle pattern (S24) most similar to an image template from the mosaic image. An approximate coordinate (S25) of the circle center of the circle pattern is acquired.

Next, a fine image adjustment is performed so as to transform the mosaic image back into the binary image (S26). The boundary coordinates x₁, x₂, y₁ and y₂ of the circle pattern are acquired respectively by using the approximate coordinate of the circle pattern as an initial point of a X-Y coordinate system to extend along a X-axis and a Y-axis (S27). The center coordinate of the circle pattern is set as

$$( \frac{{x}_{1} + {x}_{2}}{2} , \frac{{y}_{1} + {y}_{2}}{2} )$$

### (S28).

The method for finding the center coordinate of the circle pattern can be utilized not only for positioning but also to compensate offset of an image to be tested, wherein the image to be tested contains a circle pattern implemented to assist positioning.

In this method of compensating the image offset, a standard center coordinate of the circle pattern must be set first. Next, the center coordinate of the circle pattern of the image to be tested is found according to the above-mentioned method. Next, an offset amount between the standard center coordinate and the found center coordinate of the circle pattern is acquired. Finally, the image to be tested is re-positioned by using the offset amount as a position compensation value.

In addition, the present invention is not limited to finding the circle pattern. Based on the established image template, the present invention can be applied to finding different specific patterns such as rectangle, rhombus, etc. Accordingly, the present invention also provides a method for finding a specific pattern. The method comprises the following steps of: (1) capturing an image to be tested; (2) performing a binary thresholding process on the image to be tested, thereby transforming the image to be tested into a binary image; (3) performing a mosaic process on the binary image, thereby transforming the binary image into a mosaic image; and (4) utilizing a correlation coefficient method to find the specific pattern most similar to an image template from the mosaic image, wherein the image template is a desired mosaic pattern of the specific pattern

To sum up, the finding method of the present invention has the following advantages:

1. The required operation time for finding the specific pattern within the image can be shortened by means of the rough image adjustment process (mosaic process) during the image positioning process.

2. The present invention utilizes the rough image adjustment process (mosaic process) to increase the speed in finding a circle pattern within an image to be tested. Afterwards, a fine image adjustment process (binary thresholding process) is performed to find the center coordinate of the circle pattern accurately.

3. The present invention provides a method for finding the center coordinate of the circle pattern rapidly and accurately during the process for positioning image and compensating image offset. In accordance with the method of the present invention, two secants along the X-axis and the Y-axis of the circle pattern are selected randomly. The coordinate of the center points along the X-axis and the Y-axis is acquired. The coordinate of the center points is the center coordinate of the circle pattern.

4. The present invention provides a method for finding the specific pattern of the image to be tested rapidly and accurately.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for finding a specific pattern, the method being utilized for finding a center coordinate of a circle pattern within an image to be tested, comprising the steps of:
(i) capturing said image to be tested;
(ii) performing a binary thresholding process on said image to be tested, thereby transforming said image to be tested into a binary image;
(iii) performing a mosaic process on said binary image, thereby transforming said binary image into a mosaic image;
(iv) utilizing a correlation coefficient method to find said circle pattern most similar to an image template from said mosaic image, wherein said image template is a desired mosaic pattern of said circle pattern;
(v) acquiring an approximate coordinate of said circle pattern;
(vi) transforming said mosaic image back into said binary image;
(vii) acquiring a plurality of boundary coordinates x₁, x₂, y₁ and y₂ of said circle pattern respectively by using said approximate coordinate of said circle pattern as an initial point of a X-Y coordinate system to extend along a X-axis and a Y-axis; and
(viii) setting said center coordinate of said circle pattern as
$$( \frac{{x}_{1} + {x}_{2}}{2} , \frac{{y}_{1} + {y}_{2}}{2} ) .$$

2. The method according to claim 1, further comprising the step of establishing said desired mosaic pattern of said circle pattern for serving as said image template.

3. The method according to claim 1, wherein in said step (iii), said binary image is reduced into said mosaic pattern having N×N pixels according to weight of white spot.

4. The method according to claim 1, wherein said step (vii) is performed by using said approximate coordinate of said circle pattern as said initial point for finding said boundary coordinates respectively from an interior of said circle pattern to an exterior of said circle pattern.

5. The method according to claim 1, wherein prior to said step (ii), further comprises the step of designating an image range having said circle pattern from said image to be tested, thereby minimizing an entire range required for finding said circle pattern.

6. A method for finding a specific pattern, the method being utilized for finding a specific pattern in an image to be tested, comprising the steps of:
(i) capturing said image to be tested;
(ii) performing a binary thresholding process on said image to be tested, thereby transforming said image to be tested into a binary image;
(iii) performing a mosaic process on said binary image, thereby transforming said binary image into a mosaic image; and
(iv) utilizing a correlation coefficient method to find said specific pattern most similar to an image template from said mosaic image, wherein said image template is a desired mosaic pattern of said specific pattern.

7. The method according to claim 6, further comprising the step of establishing said desired mosaic pattern of said specific pattern for serving as said image template.

8. The method according to claim 6, wherein in said step (iii), said binary image is reduced into said mosaic pattern having N×N pixels according to weight of white spot.

9. The method according to claim 6, wherein prior to said step (ii), further comprises the step of designating an image range having said specific pattern from said image to be tested, thereby minimizing an entire range required for finding said specific pattern.

10. The method according to claim 6, wherein said specific pattern is a circle pattern.

11. A method for compensating an image offset, the method being utilized for compensating offset of an image to be tested that includes a circle pattern implemented to assist positioning, comprising the steps of:
(i) setting a standard center coordinate of said circle pattern;
(ii) capturing said image to be tested;
(iii) performing a binary thresholding process on said image to be tested, thereby transforming said image to be tested into a binary image;
(iv) performing a mosaic process on said binary image, thereby transforming said binary image into a mosaic image;
(v) utilizing a correlation coefficient method to find said circle pattern most similar to an image template from said mosaic image, wherein said image template is a desired mosaic pattern of said circle pattern;
(vi) acquiring an approximate coordinate of said circle pattern;
(vii) transforming said mosaic image back into said binary image;
(viii) acquiring a plurality of boundary coordinates x₁, x₂, y₁ and y₂ of said circle pattern respectively by using said approximate coordinate of said circle pattern as an initial point of a X-Y coordinate system to extend along a X-axis and a Y-axis;
(ix) setting a center coordinate of said circle pattern as
$$( \frac{{x}_{1} + {x}_{2}}{2} , \frac{{y}_{1} + {y}_{2}}{2} ) ;$$
(x) acquiring an offset amount between said standard center coordinate and said center coordinate of said circle pattern; and
(xi) re-positioning said image to be tested by using said offset amount as a position compensation value.

12. The method according to claim 11, further comprising the step for establishing said mosaic pattern of said circle pattern for serving as said image template.

13. The method according to claim 11, wherein in said step (iv), said binary image is reduced into said mosaic pattern having N×N pixels according to weight of white spot.

14. The method according to claim 11, wherein the step (viii) is performed by using said approximate coordinate of said circle pattern as said initial point for finding said boundary coordinates respectively from an interior of said circle pattern to an exterior of said circle pattern.

15. The method according to claim 11, wherein prior to the step (iii), further comprises the step of designating an image range having said circle pattern from said image to be tested, thereby minimizing an entire range required for finding said circle pattern.
